(19) United States
(12) Patent Application Publication
(10) Pub. No.: US 2015/0001349 A1
(43) Pub. Date: Jan. 1, 2015

(54) COOLING DEVICE FOR REGULATING THE TEMPERATURE OF A HEAT SOURCE OF A SATELLITE, AND METHOD FOR PRODUCING THE ASSOCIATED COOLING DEVICE AND SATELLITE

(71) Applicant: ASTRIUM SAS, SURESNES (FR)

(72) Inventor: Christophe Figus, Dremil Lafarge (FR)

(21) Appl. No.: 14/371,303

(22) PCT Filed: Jan. 11, 2013
(86) PCT No.: PCT/EP2013/050506

§ 371 Date: Jul. 9, 2014

(30) Foreign Application Priority Data
Jan. 13, 2012 (FR) 12 00110

(51) Int. Cl. B64G 1/58; F28D 15/02; B64G 1/10; F28D 15/04

(52) U.S. Cl. CPC B64G 1/58; F28D 15/04; F28D 15/02; B64G 1/10
USPC 244/171.8; 165/104.26

(57) ABSTRACT

A cooling device for regulating the temperature of a heat source of a satellite. The cooling device comprises at least one fluid loop is formed by an evaporator comprising a tank, at least one condenser, two conduits connecting the evaporator to the condenser, a heat transfer fluid flowing inside the fluid loop. The cooling device further comprises a device for pressurizing the fluid loop or a thermal damper. The thermal damper comprises a variable volume leak-tight chamber having a volume which varies on the basis of the operating temperature of the fluid loop so as to provide a substantially constant temperature inside the fluid loop.

The invention relates to a cooling device suitable for regulating the temperature of a heat source and a method for producing the associated cooling device and satellite.

### PREAMBLE AND PRIOR ART

The invention is particularly advantageously applicable in the field of the temperature regulation of dissipative equipment placed in an environment in which the temperature is likely to undergo significant variations. Dissipative equipment should be understood to mean any type of equipment or set of equipment containing heat sources when in operation. Such equipment can be electronic equipment, components in electronic equipment, any other non-electronic system producing heat.

Devices suitable for controlling the temperature of equipment embedded in a vehicle are known that comprise a two-phase fluid transfer loop with capillary pumping, often called capillary loop heat pipe, or simply loop heat pipe, thermally connecting the dissipative equipment to one or more radiators or radiative surfaces. This loop heat pipe makes it possible to transport thermal energy from a heat source, like the dissipative equipment, to a heat sink, like a radiative surface, by using the capillarity as motive pressure and the liquid/vapor change of phase as energy transport means.

The loop heat pipe generally comprises an evaporator intended to extract the heat from the heat source and a condenser intended to restore this heat at the heat sink. The evaporator and the condenser are linked by a duct in which a heat-transfer fluid circulates in the mostly liquid state in the cold part of the loop heat pipe, and a duct in which this same heat-transfer fluid circulates in the mostly gaseous state in its hot part. The evaporator comprises a tank of liquid and a capillary structure ensuring the pumping by capillarity of the heat-transfer fluid in liquid phase to a vaporization zone.

FIG. 1 describes a particular type, but one that is nevertheless representative, of a capillary loop heat pipe, represented here in cross section. A tank of fluid in the vicinity of a capillary structure is distinguished, that can advantageously be a microporous mass. The tank receives liquid originating from the condenser, and the microporous mass brings this liquid by capillarity to the vaporization zone.

The normal operating regime of a capillary loop heat pipe is a two-phase regime, the fluid being in a state that is both liquid and vapor in the loop heat pipe. This regime is achieved if the loop heat pipe is well-dimensioned in terms of volume and flow rate of the heat-transfer fluid relative to the need to transport the heat dissipated by the heat source to the heat sink. Hereinafter in the explanation, “operating point of the loop heat pipe” will be used to designate the saturation temperature and pressure at which the fluid vaporizes at the evaporator. Thus, in the space of the states of the fluid in terms of temperature and pressure, the operating points of a loop heat pipe are located on the Clapeyron curve separating the two liquid and vapor states of the fluid. FIG. 2 shows different operating points of a capillary loop heat pipe in which the heat-transfer fluid is ammonia. Three operating points P1, P2 and P3 are indicated in the figure. These points correspond to states of the fluid in the loop heat pipe determined by saturation temperature and pressure pairings of the ammonia, the numerical values of which are given here approximately (for our purposes, only orders of magnitude count): P1 (25° C., 10 bars), P2 (18° C., 8 bars), P3 (−33° C., 1 bar).

It should be recalled here that, when the capillary loop heat pipe operates in stabilized regime around an operating point such as P1, P2 or P3 (therefore outside of start-up phases, transitional phases, cases of failure, etc.), the temperature and the pressure of the fluid vary within the very loop heat pipe according to the current location thereof (condenser, tank, microporous mass, ducts) mainly because of the over-reheating of the fluid in the microporous mass, of the under-recooling of the liquid in the condenser, of the head losses in the system, of the capillary pressure within the microporous mass, etc. However, these variations are very small: typically of the order of a few degrees in temperature, a few thousand Pascals in pressure, most of the heat exchanges having to be done optimally by a change of state of the fluid, therefore in the vicinity of the saturation curve. In all the cases of steady state operation, they will be considered to be negligible compared to the much greater variations of the thermal environment that are being considered here, in particular the thermal power of the heat source and/or the temperature of the heat sink.

The operating point of the loop heat pipe results from a balance between, on the one hand, the flow rate and the temperature of the fluid cooled at the condenser arriving in the tank, and, on the other hand, the reheating by the heat source of the fluid contained in the evaporator and the tank. For one and the same thermal power delivered by the heat source, it is assumed that the loop heat pipe is at the operating point P1, that is to say at a vaporization temperature of 25° C., and that the temperature of the condenser is lowered to −30° C. This will have the effect of lowering the temperature of the liquid at the inlet of the tank, and in the tank. Because of this, the volume of the liquid will contract, which leads to a fluid pressure drop in the loop heat pipe. The vaporization temperature of the fluid will therefore also drop and the loop heat pipe will necessarily change operating point, to reach an operating point with lower saturation temperature and pressure than the point P1. Its operating point will drop along the Clapeyron curve, passing through the state P2 and toward the point P3.

This phenomenon can be observed in many cases of application where the thermal environment of the heat sink to which the dissipative equipment item is linked fluctuates according to external conditions. Such is the case for example of radiators placed on the outer surface of a craft (missile, airplanes, satellites) moving in an environment subject to temperature variations (as a function of altitude for example) or solar lighting variations (in the case of satellites). The temperature fluctuations of the radiator as a function of the temperature of the environment or of the solar incidence can be typically 50° C. As explained previously, the use of a capillary loop heat pipe without a regulation device leads to equally significant variations of the temperature of the equipment item to be cooled, which can be prejudicial to its operation.

Such an exemplary application is illustrated by FIG. 3 which schematically represents, in a cross-sectional view, the internal arrangement of a satellite which shows a dissipative equipment item and a system for controlling the temperature of this equipment consisting of a capillary loop heat pipe whose evaporator is placed in thermal contact with the equipment and whose condenser is placed in thermal contact with a radiator situated on one of the faces of the satellite, at the periphery of the body of the satellite. The temperature of the radiator will vary significantly along with its exposure to sunlight. A typical variation of the temperature of the radiator is around 50 degrees (it depends on the maximum solar incidence, on the thermal characteristics of the radiator, etc.).

FIG. 4 represents the trend over time of the temperature of the condenser and of the temperature of the operating point of the loop heat pipe when a capillary loop heat pipe according to the prior art is used. It can be seen that the two temperatures undergo practically the same variations (to within a few degrees).

In order to limit the variations of the saturation temperature of a capillary loop heat pipe whose condenser is subject to significant temperature variations, other elements must be implemented. The most recent prior art consists in using active systems, such as reheating systems. Electrical resistors can be used to directly reheat the equipment for which the temperature is to be stabilized. It is also possible to use electrical resistors to reheat the tank of liquid of one or more loop heat pipes in order to vary their conductance in order also to control the temperature of the equipment. The limitations of this type of device are due to the power consumed which can become high (a few tens to a few hundreds of watts) as well as the complexity of the device (temperature probes, and a control member processing the temperature measurements to calculate the control commands to be sent to the electrical resistors are needed).

Other solutions can be envisaged like the use of active systems, such as a device of bypass type as represented in the document WO2010037872A1, or materials with change of phase described in the document WO2008001004A1 aiming to limit the temperature variations of the equipment. However, with this type of device, there are constraints with regard to operation and stability in certain temperature ranges which lead to greater or lesser temperature swings on the equipment. Also, the use of devices of bypass type leads, in the case where the system operates at low temperature, to a total short-circuit of the condenser (which is fixed to the radiator) and therefore to a need for power to reheat the latter to prevent the freezing of the fluid located in the condenser which is then no longer in motion.

In the case of the use of passive systems of material with change of phase type, there are constraints with regard to operation which lead to a limitation in time of the capacity of the system to regulate given the limited mass of material with change of phase.

As described in the document EP2291067A1, also known are cooling devices of an electrical power converter comprising a loop heat pipe comprising a condenser and an evaporator linked to a tank comprising means for controlling pressure and/or temperature parameters such as a temperature sensor and a pressure sensor. A duct links the condenser and the evaporator and the tank to the condenser. In the case where temperature measurements are used to regulate the temperature inside the tank, a resistor to heat the tank, a fan to cool the tank and an outgassing valve are used. In the case where pressure measurements are used, a compressor and a valve are used. A pressurizing gas is then injected into the tank and enters into contact with the heat-transfer fluid, which induces drawbacks such as the stopping of the loop heat pipe in the event of a leak of this gas in the duct.

### EXPLANATION OF THE INVENTION

The aim of the invention is notably to propose a passive temperature regulation device that makes it possible to greatly reduce (without canceling) the pressure and temperature differences in a capillary loop heat pipe when the temperature of the heat sink used for the temperature regulation and/or the thermal power dissipated by the heat source vary significantly, and do so without the drawbacks of the prior art.

To this end, the invention relates to a cooling device suitable for regulating the temperature of a heat source comprising at least one capillary loop heat pipe formed by:
a capillary evaporator linked to at least one tank of fluid,
at least one condenser,
a heat-transfer fluid circulating in the capillary loop heat pipe,
a duct in which the heat-transfer fluid circulates in the mostly liquid state,
a duct in which the heat-transfer fluid circulates in the mostly gaseous state,
the ducts linking the evaporator to the condenser so as to form a closed fluid circulation circuit.

The cooling device further comprises a device called “thermal damper”, consisting of a variable volume leak-tight chamber comprising a volume stiffness adapted for the variable volume leak-tight chamber to be deformed passively within a given operating range of the capillary loop heat pipe as a function of the variation of volume and of distribution of the fluid in the capillary loop heat pipe.

“Volume stiffness” should be understood to mean the absolute value of the ratio between the pressure variation exerted on the chamber and the variation of volume of the chamber which results therefrom.

“Passively” should be understood to mean the fact that there is no active system for controlling the deformation of the chamber requiring sensors and/or actuators and/or a computation member sending control commands to the actuators as a function of the measurements delivered by the sensors.

“Variation of volume of the fluid” should be understood to mean the variation of the volume of the liquid and vapor together as a function of the temperature at all points of the loop heat pipe for a given pressure.

“Variation of distribution of the fluid” should be understood to mean the fact that the liquid is distributed differently within the fluid ducts and the tank as a function of the temperature at all points of the loop heat pipe.

It is understood that the accuracy with which the chamber would actually be deformed in said given operating range is quite relative, for lack of production or errors in the modeling of the physical phenomena involved.

An operating point of the loop heat pipe is, by definition, the saturation temperature and pressure of the fluid at the points of vaporization of the fluid in the loop heat pipe. “Operating range of the loop heat pipe” should be understood to mean a set of operating points of the loop heat pipe that correspond to a saturation temperature interval, or, equivalently, a saturation pressure interval, at the point of vaporization of the fluid in the loop heat pipe.

For a given operating point, the temperature at all points of the loop heat pipe varies as a function of the environmental conditions (temperature of the cold sink, power transported).

In all the embodiment cases, at least a part of the chamber is in contact with the fluid of the loop heat pipe.

A typical order of magnitude of the volume stiffness of the chamber for ammonia is from 1 to some tens of bars per cubic centimeter. This stiffness depends on the saturation pressure of the heat-transfer fluid concerned.

In a preferred first class of embodiments, the chamber of the thermal damper is sealed and it is situated inside the loop heat pipe.

In a first implementation of this embodiment class, the chamber of the thermal damper comprises a bellows.

In a second implementation of this embodiment class, the chamber of the thermal damper comprises a deformable and hermetically-sealed jacket, and a spring positioned inside this deformable jacket.

In a third implementation, the chamber of the thermal damper comprises a deformable and hermetically-sealed jacket, and a fluid positioned inside this deformable jacket.

In yet another implementation, the chamber of the thermal damper comprises a hermetically-sealed deformable jacket, and a spring and a fluid positioned inside this deformable jacket.

In these last three implementations, the deformable jacket can take the form of a bellows.

Advantageously, but not necessarily, the thermal damper is situated inside the tank.

The thermal damper is more advantageously situated in the part of the loop heat pipe situated downstream of the condenser where the liquid phase of the heat-transfer fluid considered is mainly situated.

In a second, different class of embodiments, the chamber of the thermal damper is a part of the loop heat pipe containing fluid.

In an exemplary implementation of this other class of solutions, the thermal damper is a part of the loop heat pipe whose wall consists of a metal bellows.

The latter can be welded to a non-deformable wall of the loop heat pipe.

For example, the thermal damper is a part of the tank.

In all the production cases, at least one mechanical abutment can be used to limit the variation of volume of the chamber.

The maximum variation of the volume of the chamber of the thermal damper within its deformation range is adapted for the thermal damper to produce an effect over a given operating range of the loop heat pipe.

“Produce an effect” should be understood to mean the fact that the operating point of the loop heat pipe for a given environment of the loop heat pipe (heat source and heat sink) differs depending on whether the loop heat pipe is provided with a thermal damper or not. In order to substantially maximize the operating range of the device, the maximum variation of the volume of the chamber of the thermal damper is between 10% and 50% of the total volume of the loop.

Advantageously, the temperature regulation device further comprises a calibration device modifying the set pressure of the thermal damper.

For the first embodiment class, “set pressure” should be understood to be the maximum pressure of the fluid beyond which the volume of the chamber of the thermal damper is minimum and cannot vary more. For the second embodiment class, “set pressure” should be understood to mean the additional external pressure which is exerted on the thermal damper in order to artificially increase its volume stiffness.

The calibration device of the thermal damper comprises at least one device suitable for varying the volume stiffness of the chamber of the thermal damper.

Moreover, in order to limit the cooling of the equipment when the temperature of the heat sink falls below a threshold, it is advantageous for the increase in the volume of the chamber to passively obstruct the arrival of liquid in the tank of the capillary loop heat pipe when said volume reaches a given value.

It is also advantageous for the variation of volume and the volume stiffness of the thermal damper to be adjusted such that the obstruction is performed automatically when the temperature at the condenser falls below a given threshold.

In order to facilitate the restarting of the loop heat pipe on the basis of a state in which the arrival of liquid in the tank is blocked, it is advantageous to use a reheating system that makes it possible to increase the temperature and the pressure of the fluid in contact with the thermal damper.

The invention further relates to a method for producing the device according to the invention, characterized in that it comprises the following steps:
choice of a set pressure Pmax, corresponding to an operating point for which the saturation temperature is Tmax and the saturation pressure is Pmax,
choice of a minimum saturation temperature Tsat<Tmax corresponding to a saturation pressure Psat,
choice of a temperature Tmin such that Tmin<Tsat,
calculation of the variation of volume and of distribution of the fluid in the loop heat pipe between the operating point Tmax, Pmax, and the operating point at which the liquid is at the temperature Tmin and the vapor is at the temperature Tsat,
calculation of the variation of volume DV of the fluid between these two operating points at the place where the thermal damper is situated,
production of a variable volume leak-tight chamber whose set pressure is equal to Pmax, the maximum variation of volume is greater than or equal to DV and for which the volume stiffness is substantially equal to (Pmax−Psat)/DV.

It is also advantageous for the variation of volume and the volume stiffness of the thermal damper to be adjusted such that the obstruction is performed automatically when the temperature of the operating point falls below a given threshold.

The invention is also aimed at a satellite comprising at least one radiative surface, characterized in that it is equipped with a cooling device according to the invention comprising a condenser in thermal contact with said radiative subject to temperature variations of the environment.

### PRESENTATION OF THE FIGURES

The invention will be better understood on reading the following description and on studying the figures accompanying it. These figures are given only by way of illustration and are in no way limiting to the invention. They show:

FIG. 1: a graphic representation of a capillary loop heat pipe of the prior art;

FIG. 2: a graphic representation of the various operating points of a loop heat pipe according to the prior art in steady-state regime;

FIG. 3: a schematic representation of a satellite comprising equipment cooled by a capillary loop heat pipe linked to a radiator situated on the outside of the satellite;

FIG. 4: a graphic representation of the trend of the temperatures of the radiator and of the equipment as a function of the lighting of the radiator by the sun when the capillary loop heat pipe is in accordance with the commonest prior art with no thermal damping system;

FIGS. 5a, 5b, 5c, 5d: schematic representations of various embodiments of the thermal damper device according to the invention, following a first class of implementation, FIG. 5b showing an exemplary embodiment with obstruction of the liquid duct at low temperature;

FIG. 6: a schematic representation of a production of the thermal damper device according to a second class of implementation of the invention;

FIGS. 7a-7b: graphic representations of the trend of the temperatures of the radiator and of the equipment as a function of the lighting of the radiator by the sun when the capillary loop heat pipe has a thermal damper according to the invention;

FIG. 8: a functional diagram illustrating the various steps of the method for producing the cooling device according to the invention.

The elements that are identical, similar or analogous retain the same reference from one figure to another.

### DETAILED DESCRIPTION OF AN EMBODIMENT OF THE INVENTION

FIG. 1 represents certain details of a capillary loop heat pipe 35. This loop heat pipe 35 makes it possible to transport thermal energy from a heat source 20, for example a dissipative equipment item, to a heat sink 15, for example a radiative surface, by using the capillarity as motive pressure and the change of liquid/vapor phase of a heat-transfer fluid (not represented in the figure) as energy transport means, in order to evacuate the thermal energy produced by the dissipative equipment item 20 via the radiative surface 15.

Dissipative equipment 20 should be understood to mean any type of equipment or set of equipment containing heat sources when in operation. Such equipment can be electronic equipment, components inside electronic equipment, any other non-electronic system producing heat.

The loop heat pipe 35 comprises an evaporator 40, positioned against the equipment item 20, intended to extract heat from the equipment item 20, and a condenser 45, positioned against the radiative surface 15, intended to evacuate this heat into space via the radiative surface 15. The evaporator 40 and the condenser 45 are linked by a duct 50 in which the heat-transfer fluid circulates in the mostly liquid state and a duct 60 in which the heat-transfer fluid circulates in the mostly gaseous state. The evaporator 40 comprises a tank 65 of fluid linked to a microporous mass 66 ensuring the pumping of the heat-transfer fluid in liquid phase by capillarity. The heat imparted to the evaporator 40 by the equipment item 20 increases the temperature of the heat-transfer fluid at the microporous mass 66, which provokes the vaporization of the heat-transfer fluid in the vaporization zone of this microporous mass 66. The vapor that is thus created is evacuated by the duct 60, and condenses at the condenser 45. The fluid leaving the condenser 45 returns to the evaporator 40 via the duct 50.

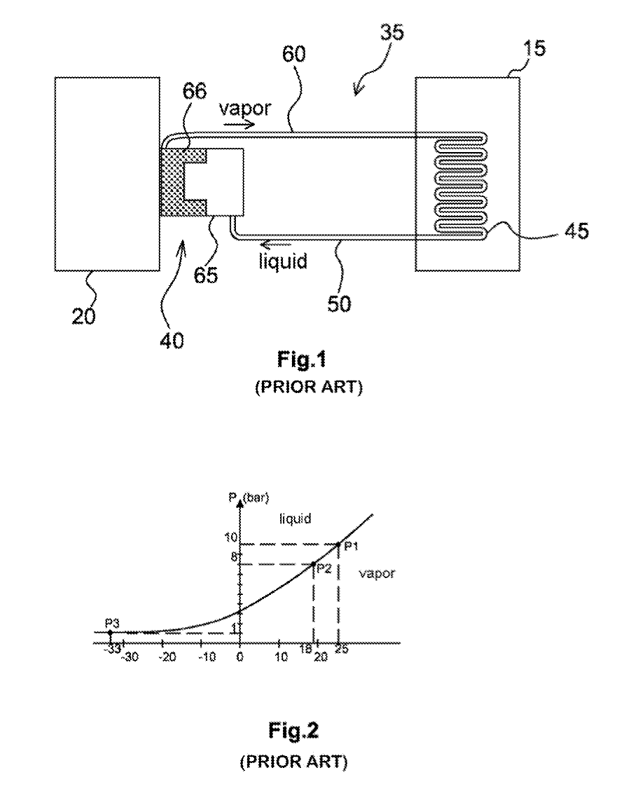

The normal operating regime of a capillary loop heat pipe 35 is a two-phase regime, the fluid being in a state that is both liquid and vapor in the loop heat pipe 35. This regime is achieved if the loop heat pipe 35 is well-dimensioned in terms of volume and flow rate of the heat-transfer fluid relative to the need to transport the heat dissipated by the heat source 20 to the heat sink 15. Hereinafter in the explanation, “operating point of the loop heat pipe” will be used to designate the saturation temperature and pressure at which the fluid vaporizes at the points of vaporization of the fluid in the loop heat pipe, that is to say at the evaporator 40. Thus, in the space of the states of the fluid in terms of temperature and pressure, the operating points of a loop heat pipe 35 are located on the Clapeyron curve separating the two liquid and vapor states of the fluid. FIG. 2 shows different operating points of a capillary loop heat pipe in which the heat-transfer fluid is ammonia. Three operating points P1, P2 and P3 are indicated in the figure. These points correspond to states of the fluid in the loop heat pipe determined by saturation temperature and pressure pairings of the ammonia, the numerical values which are given here approximately (for our purposes, only the orders of magnitude count): P1 (25° C., 10 bars), P2 (18° C., 8 bars), P3 (−33° C., 1 bar).

It should be recalled here that, when the capillary loop heat pipe 35 operates in steady-state regime around an operating point such as P1, P2 or P3 (therefore outside start-up phases, transitional phases, cases of failure, etc.), the temperature and the pressure of the fluid vary within the very loop heat pipe 35 according to the current location thereof (condenser 45, tank 65, microporous mass 66, ducts 50, 60) mainly because of the over-reheating of the fluid in the microporous mass 66, of the under-recooling of the liquid in the condenser 45, of the head losses in the system, of the capillary pressure within the microporous mass 66, etc. However, these variations are very small: typically of the order of a few degrees in temperature, a few thousand Pascals in pressure, most of the heat exchanges having to be done optimally by change of state of the fluid, therefore in the vicinity of the saturation curve. In all the cases of steady-state operation, they will be considered to be negligible compared to the much greater variations of the thermal environment that are being considered here, in particular the thermal power of the heat source 20 and/or the temperature of the heat sink 15.

The operating point of the loop heat pipe 35 results from a balance between, on the one hand, the flow rate and the temperature of the fluid cooled at the condenser 45 arriving in the tank 65, and, on the other hand, the reheating by the heat source 20 of the fluid contained in the evaporator 40 and the tank 65. For one and the same thermal power delivered by the heat source 20, it is assumed that the loop heat pipe 35 is at the operating point P1, that is to say at a vaporization temperature of 25° C., and that the temperature of the condenser 45 is lowered to −30° C. This will have the effect of lowering the temperature of the liquid at the inlet of the tank 65, and in the tank 65. Because of this, the volume of the liquid will contract, which leads to a fluid pressure drop in the loop heat pipe 35. The vaporization temperature of the fluid will therefore also drop and the loop heat pipe 35 will necessarily change operating point, to reach an operating point with lower saturation temperature and pressure than the point P1. Its operating point will drop along the Clapeyron curve, passing through the state P2 and toward the point P3.

This phenomenon can be observed in many cases of application where the thermal environment of the heat sink 15 to which the dissipative equipment item 20 is linked fluctuates according to external conditions. Such is the case for example of radiators placed on the outer surface of a craft (missile, airplanes, satellites) moving in an environment subject to temperature variations (as a function of altitude for example) or solar lighting variations (in the case of satellites). The temperature fluctuations of the radiator as a function of the temperature of the environment or of the solar incidence can be typically 50° C. As explained previously, the use of a capillary loop heat pipe 35 without a regulation device leads to equally significant variations of the temperature of the equipment item 20 to be cooled, which can be prejudicial to its operation.

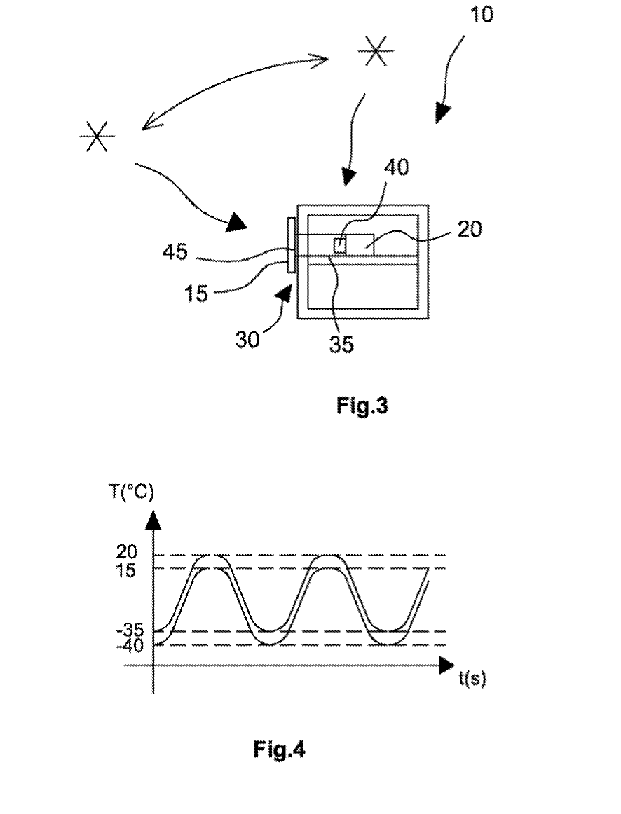

FIG. 3 shows a satellite 10 comprising a radiative surface 15, an equipment item 20 dissipating heat inside the satellite 10, and a cooling device 30 of capillary loop heat pipe 35 type making it possible to evacuate into the space the heat produced by the equipment item 20 via the radiative surface 15. The evaporator 40 of the loop heat pipe 35 is placed in thermal contact with the equipment item 20. The condenser 45 of the loop heat pipe 35 is placed in thermal contact with the radiative surface 15 situated on one of the faces of the satellite 10, at the periphery of the body of the satellite 10. The temperature of the radiative surface 15 will vary significantly along with its exposure to sunlight. A typical variation of the temperature of the radiative surface 15 is around 50 degrees (it depends on the maximum solar incidence, on the thermal characteristics of the radiative surface 15, etc.).

The thermal environment of the satellite 10 fluctuates according to the incidence of the sun, leading to temperature fluctuations on the radiative surface 15 and the onboard equipment item 20 in the case where this radiative surface 15 is alternately lit by the sun and in shadow.

For the purposes of illustration, it will be assumed that the heat-transfer fluid of the loop heat pipe 35 is ammonia.

In the exemplary embodiments presented above, a passive device 70 called thermal damper is positioned inside the tank 65 of the evaporator. In other exemplary embodiments that are not represented, the thermal damper 70 is positioned in another part of the loop heat pipe 35, for example inside another tank of fluid not directly connected to the microporous mass 66, this tank being advantageously connected to the duct 50 linking the condenser 45 to the tank 65 of the evaporator 40, and therefore mostly filled with liquid in low temperature operating condition. The operation of the thermal damper 70 is the same in both cases. It makes it possible to compensate the variations of volume and of distribution of the fluid inside the loop heat pipe 35 when the operating point of the loop heat pipe 35 varies, either because of a variation of temperature of the radiative surface 15, linked to the variations of the environment, or because of variations of dissipation of the equipment item 20.

The thermal damper 70 consists of a variable volume leak-tight chamber 71, the volume of said chamber 71 varying passively as a function of the variation of volume and of the distribution of the fluid in the loop heat pipe 35.

“Passively” should be understood to mean the fact that there is no active system for controlling the deformation of the chamber 71 requiring sensors and/or actuators and/or a computation member sending control commands to the actuators as a function of the measurements delivered by the sensors.

“Variation of the volume of the fluid” should be understood to mean the variation of the volume of the liquid and vapor together as a function of the temperature at all points of the loop heat pipe 35 for a given pressure.

“Variation of distribution of the fluid” should be understood to mean the fact that the liquid is distributed differently within the fluid ducts 50, 60 and the tank as a function of the temperature at all points of the loop heat pipe 35.

The thermal damper 70 is adapted for the volume of the chamber 71 to vary within a given operating range of the loop heat pipe 35.

An operating point of the loop heat pipe 35 is, by definition, the saturation temperature and pressure of the fluid at the points of vaporization of the fluid in the loop heat pipe 35. “Operating range of the loop heat pipe” should be understood to mean a set of operating points of the loop heat pipe 35 that correspond to a saturation temperature interval, or, equivalently, a saturation pressure interval, at the point of vaporization of the fluid in the loop heat pipe 35.

For a given operating point, the temperature at all points of the loop heat pipe 35 varies as a function of the environmental conditions (temperature of the radiative surface 15, power transported).

In all the embodiment cases, at least a part of the chamber 71 is in contact with the fluid of the loop heat pipe 35.

The chamber 71 has a volume stiffness which advantageously produces the passive variation of its volume as a function of the variation of volume and of distribution of the fluid in the loop heat pipe 35.

“Volume stiffness” should be understood to mean the absolute value of the ratio between variation of pressure exerted on the chamber 71 and the variation of volume of the chamber 71 which results therefrom.

Advantageously, the thermal damper 70, in particular its volume stiffness, is adapted to be deformed within a given operating range of the loop heat pipe 35.

It is understood that the accuracy with which the chamber 71 would actually be deformed in said given operating range is quite relative, for lack of production or error in the modeling of the physical phenomena involved.

A typical order of magnitude of the volume stiffness of the chamber 71 for ammonia is 1 to some tens of bars per cubic centimeter. This stiffness depends on the saturation pressure of the heat-transfer fluid concerned.

In a first preferred class of embodiments, the leak-tight chamber 71 of the thermal damper 70 is sealed and it is situated inside the loop heat pipe 35.

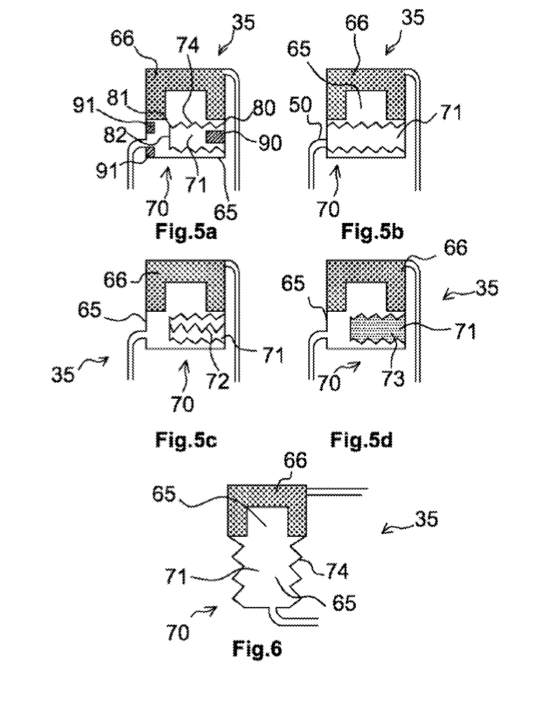

Thus, according to a first embodiment of the device 30 illustrated in FIG. 5a, the thermal damper 70 comprises a sealed, leak-tight variable volume chamber 71, situated in the tank 65 of the loop heat pipe 35. This chamber 71 comprises a hermetically-sealed deformable jacket taking the form of a metal bellows 74 of which one end 80 is welded to an inner wall of the loop heat pipe 35, and the other end 81 is welded to a rigid and planar metal plate 82. As a variant, the metal bellows 74 and the metal plate 82 are not welded but are manufactured as a single piece. An almost total vacuum is produced in the leak-tight chamber 71, the residue of gas present in the chamber 71 at the time of its manufacture being advantageously ammonia vapor so as not to disrupt the operation of the loop heat pipe 35 in the case of possible leaks of this residual gas inside the loop heat pipe 35.

The elasticity of the metal bellows 74 enables the chamber 71 to adapt its volume automatically to compensate the variation of volume and of distribution of the fluid in the loop heat pipe 35 upon significant variations of the temperature.

To simplify, assuming that a total vacuum has been produced in the chamber 71 (a person skilled in the art will be able to extend the reasoning and the calculations to the general case where there remains a residual pressure of gas inside the chamber 71), the metal bellows 74 exhibits a maximum elongation Zmax in the vacuum. The chamber 71 then exhibits a maximum volume Vmax.

The chamber 71 exhibits a minimum volume Vmin when the elongation of the metal bellows 74 has reached its minimum value Zmin, which occurs when the outer pressure acting on the chamber 71 is greater than a value Ptar, called set pressure, because, for example, at this pressure, at least one abutment 90 prevents the metal bellows 74 from compressing further. DVmax is used to denote the maximum variation of the chamber 71: DVmax=Vmax-Vmin.

Advantageously, the metal bellows 74 is in its range of elasticity throughout the range of variation of its elongation, which will be assumed throughout the description. If it is also assumed (still for the purposes of simplifying the description and without diminishing any generality of the invention) that the stiffness of the metal bellows 74 is constant over the range of variation of its volume, the volume stiffness K of the chamber 71 of the thermal damper 70 will also be constant over this range. The result is that the volume V of the thermal damper 70 will be able to vary within an external pressure range P ranging from a zero pressure to pressure Ptar with the following relationships:

P=K·(V−Vmin)

In particular

Ptar=K·(Vmax−Vmin)=K·DVmax,

and

K=Ptar/DVmax.

Note that when the pressure of the fluid being exerted on the thermal damper 70 is greater than the set pressure Ptar, the volume of the chamber 71 of the thermal damper 70 can no longer vary. The damper 70 then no longer has any notable influence on the operation of the loop heat pipe 35.

In the example considered of a loop heat pipe 35 with ammonia, it is assumed, to set an order of magnitude, that the set pressure is 10 bar and that, at the operating point P1 of the loop heat pipe 35 (at which the saturation pressure is 10 bar and the saturation temperature is 25° C.), the chamber 71 of the loop heat pipe 35 is approximately subject to this pressure of 10 bar. Examine how the thermal damper 70 will act on the operation of the loop heat pipe 35 when the temperature of the radiative surface 15 decreases slowly to a temperature below −30° C. under the effect of a drop in temperature of the environment. From the operating point P1, the temperature of the heat-transfer fluid will lower at the outlet of the condenser 45 and in the tank 65 to a value close to −30° C. Without the thermal damper 70, this lowering of temperature would produce a lowering of pressure of the fluid in the loop heat pipe 35 and would cause the operating point of the loop heat pipe 35 to drop to a saturation temperature close to −30° C., corresponding to a saturation pressure of 1 bar (operating point P3). The equipment item 20 would then be subject to these very low temperatures.

The thermal damper device 70 makes it possible to completely or partly compensate the two main effects resulting from the decrease in the temperature of the fluid (essentially liquid) coming from the condenser 45. Firstly, the cooling provokes a decrease in the volume of the fluid which can be compensated by an equivalent variation of the volume of the chamber 71 of the damper 70. Also, the lowering of the temperature in the condenser 45 modifies the distribution of the liquid within the loop heat pipe 15 because the condensation of the vapor arriving from the evaporator 40 takes place increasingly upstream in the fluid circulation circuit. There will therefore be increasingly more liquid (in volume) at the condenser 45, which will draw a corresponding volume of liquid from the tank 65. The thermal damper 70 will also make it possible to compensate this fluid volume variation in the tank 65.

It is important to note that, according to the invention, this compensation of the variations of volume or of distribution of the fluid in the loop heat pipe is performed entirely passively by the relatively low volume stiffness of the device and by the great variations of volume of the device which result therefrom.

The maximum variation of the volume of the chamber of the thermal damper within its deformation range is adapted for the thermal damper to produce an effect over a given operating range of the loop heat pipe.

“Produce an effect” should be understood to mean the fact that the operating point of the loop heat pipe for a given environment of the loop heat pipe (heat source and heat sink) differs depending on whether the loop heat pipe is provided with a thermal damper or not.

In order to substantially maximize the operating range of the device, the maximum variation of the volume of the chamber of the thermal damper is between 10% and 50% of the total volume of the loop.

In total, the thermal damper 70 will compensate a variation of volume DV (here a decrease in volume) of liquid in the tank 65. In this state, the pressure P that it exerts on the fluid corresponds to the variation DV of volume of the chamber:

P=Ptar−K·DV

i.e.

P=Ptar·(1−DV/DVmax)

Consequently, the thermal damper 70 imposes a saturation pressure Psat=P at the point where fluid is vaporized, that is to say at the points of the loop heat pipe 35 were the heat transfer with the equipment item 20 takes place.

Thus, it can be seen that if DV/DVmax is small compared to 1, the saturation pressure will remain close to Ptar=10 bar in this example, therefore the saturation temperature at which the zone of evaporation of the fluid in contact with the equipment item 20 will remain close to 25° C. is located.

Generally, the thermal damper 70 will be all the more effective when the ratio DV/DVmax is small. Consider the situation that, at the operating point at which the liquid is at −30° C. in the condenser, the decrease in the volume DV of liquid in the tank 65 is five times smaller than the maximum possible variation DVmax of the chamber 71 of the thermal damper 70. The saturation pressure of the fluid will then be equal to Psat=10 bar×(1−⅕)=8 bar. The saturation temperature of the fluid will therefore be close to +18° C. (operating point P2), and the heat transfer between the equipment item 20 and the loop heat pipe 35 will take place at this temperature instead of a temperature of −30° C. without thermal damper 70. Generally, it will be advantageous for the variation of volume of the chamber 71 of the thermal damper 70 to be between 10% and 50% of the total volume of the fluid in the loop heat pipe 35.

This effect of the thermal damper 70 persists as long as no constraint prevents the bellows 74 from being elongated (like an abutment 90, 91 limiting its travel). Another condition for the thermal damper 70 to work is that the thermal power of the equipment item 20 should be sufficient to change the temperature of the fluid from −30° C. in the tank 65 to +18° C. in the vaporization zone.

When the temperature of the fluid continues to drop but the pressure exerted by the chamber 71 can no longer be transferred to the fluid because the bellows 74 is fully extended or it is at abutment, the operating point of the loop heat pipe 35 will move to very low saturation temperatures and pressures corresponding to the operation of a loop heat pipe 35 without thermal damper 70.

To limit this phenomenon of cooling beyond the limits of operation of the thermal damper 70 and safeguard the equipment item 20 from a significant under-recooling, it may be advantageous for the elongation of the bellows 74 to itself provoke the stopping of the circulation of the fluid in the loop heat pipe 35, for example by arranging that, under the effect of the elongation of the bellows 74 when there is continuous lowering of the temperature of the fluid at the outlet of the condenser 45, the bellows 74 obstructs, even totally blocks, the arrival from the duct 50 of liquid into the tank 65, as is illustrated in FIG. 5b.

If the external conditions change and the condenser 45 is reheated, it is essential to have the loop heat pipe 35 restarted by starting from this situation where the arrival of liquid is obstructed. To facilitate this start-up, it may be advantageous to reheat the tank 65 or the liquid duct 50 upstream of the tank 65, for example with an electrical resistor, in order to thus increase the temperature and the pressure of the fluid within the tank 65 which will cause the chamber 71 to contract and the arrival of liquid to be freed up without waiting for the overall reheating of the loop heat pipe 35.

In the variant of the embodiment represented in FIG. 5c, the chamber 71 further comprises a spring 72 positioned inside the chamber 71. The spring 72 is compressed between an inner wall of the loop heat pipe 35 and the plate 82 of the bellows 74. When the spring 72 has a stiffness much greater than the bellows 74, the utility of the bellows 74 is essentially to provide a leak-tight and deformable wall, the volume stiffness of the chamber 71 being a function primarily of the stiffness of the spring 72. The mode of operation of the thermal damper 70 is the same as previously.

In another embodiment illustrated in FIG. 5d, a fluid 73, for example a gas or a two-phase fluid, is positioned inside the chamber 71 instead of the spring 72. The pressure exerted by the fluid 73 replaces the pressure exerted by the spring 72. Alternatively, it is possible to use, in combination, the spring 72 and the fluid 73 positioned inside the chamber 71. The stiffness characteristics of the spring 72 and/or of the equivalent stiffness of the fluid 73 defined by the pressure variation of the fluid for a variation of volume define the set pressure of the thermal damper 70. The travel of the spring 72 and/or the volume of the fluid 73 define the maximum variation of volume of the chamber 71, and, thereby, the operating range of the thermal damper 70.

The use of a metal bellows 74 made of a material with shape memory and/or a spring 72 made of a material with shape memory and/or of a fluid 73 make it possible to modify the operation of the thermal damper 70, in particular its set pressure, by heating or cooling the metal bellows 74 and/or the spring 72 and/or the fluid 73. When a spring 72 is used it is also possible to modify the operation of the damper 70 by using a mechanism making it possible to contract the spring 72.

FIG. 6 shows another embodiment of the invention according to a second class of implementation, in which the chamber of the thermal damper 70 is a part of the loop heat pipe 35 containing fluid. For this second class of implementation, “set pressure” should be understood to mean the additional external pressure which is exerted on the thermal damper 70 in order to artificially increase its volume stiffness. The leak-tight and variable volume chamber 71 of the thermal damper 70 is, here, the very body of the tank 65 of which a part has the form of a metal bellows 74. The bellows 74 can be welded to a non-deformable wall of the loop heat pipe 35. The volume of the chamber 71 varies passively when the fluid expands. The previous description of the mode of operation of the thermal damper 70 can be reprised to explain the operation of the thermal damper device 70 when the temperature of the heat sink 15 is lowered apart from the fact that the operation of the bellows 74 is here reversed: the bellows 74 elongates when the pressure of the fluid increases in the loop heat pipe 35, it contracts when the pressure drops. The set pressure Ptar can then be advantageously replaced by a reference pressure at an operating point of the loop heat pipe 35, for example a pressure of 10 bar corresponding to the operating point P1. The only change compared to the previous embodiments is that nothing prevents the elongation of the bellows 74 when the temperature and the pressure of the fluid in the loop heat pipe 35 increases, other than its elastic limit then its breaking point.

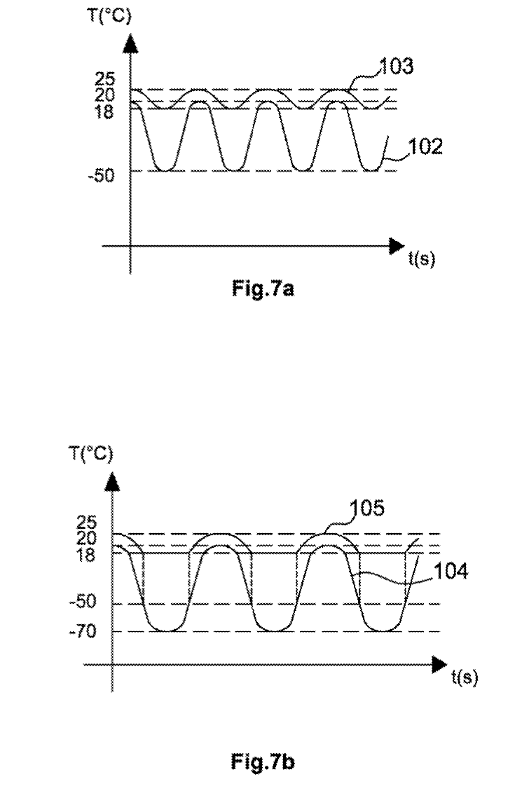

FIG. 7a shows the trend of the temperature of the condenser 45 (curve 102) and of the saturation temperature in the vaporization zone of the evaporator 40 (curve 103) in the case where the thermal damper 70 is in its operating range. The curve 103 follows the variations of the curve 102, while remaining within a range of temperatures between 18° C. and 20° C. when the curve 102 trends between −50° C. and 20° C. The saturation temperature (curve 103) does not therefore undergo a great variation over time by virtue of the thermal damper 70.

FIG. 7b shows the trend of the temperature of the condenser 45 (curve 104) and of the saturation temperature in the vaporization zone of the evaporator 40 (curve 105) in the case where the thermal damper 70 departs from its operating range. The curve 105 follows the variations of the curve 104, while remaining within a range of temperatures between 18° C. and 20° C. when the curve 104 trends between −50° C. and 20° C. When the curve 104 drops below −50° C., the curve 105 ceases to drop to stabilize at 18° C. This is due to the stopping of the circulation of the fluid by the bellows 74 as shown in FIG. 6b. The saturation temperature (curve 103) does not therefore undergo a great variation over time by virtue of the thermal damper 70.

By virtue of the invention, the energy supplied by the equipment item 20 is always transmitted to the radiative surface 15, which prevents the problems encountered by the bypass technology, such as, for example, the short-circuits of the condenser 45 and therefore the need to reheat the condenser 45 to avoid the freezing of the fluid located in said condenser 45 which is then no longer in motion. Furthermore, the invention makes it possible, by virtue of the hydraulic damper 70, to damp the temperature oscillations originating from the radiative surface 15. The invention is then not limited over time in its capacity to regulate unlike the system that makes use of a material with change of phase.

Unlike an active system such as a reheating system, the cooling device of the invention is simple and is not limited in terms of consumed power.

Unlike the active systems such as a device of bypass type or materials with change of phase, the cooling device of the invention is not subject to constraints of operation and of stability in certain temperature ranges.

Unlike the cooling device comprising an outgassing valve, the cooling device of the invention avoids injecting a pressurizing gas that can cause the loop heat pipe 35 to be stopped.

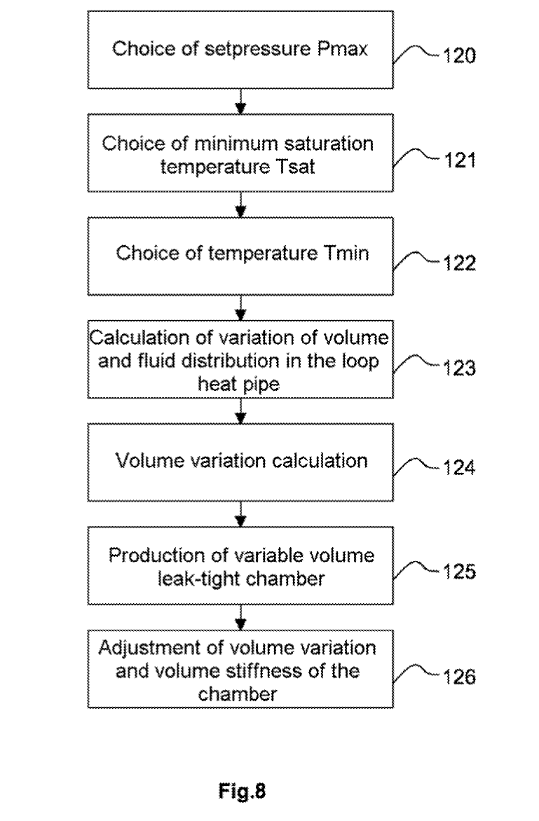

FIG. 8 shows a method for producing the cooling device. This method comprises a first step 120 of choosing a set pressure Pmax, corresponding to an operating point of which the saturation temperature is Tmax and the saturation pressure is Pmax. A second step 121 is to choose a minimum saturation temperature Tsat lower than the saturation temperature Tmax corresponding to a saturation pressure Psat and a third step 122 is to choose a minimum temperature Tmin such that this minimum temperature Tmin is lower than the minimum saturation temperature Tsat. In a step 123, the variation of volume and of distribution of the fluid in the capillary loop heat pipe 35 between the operating point of saturation temperature Tmax and of saturation pressure Pmax, and the operating point at which the liquid is at minimum temperature Tmin and the vapor is at minimum saturation temperature Tsat is calculated. Then, in a step 124, the variation of volume DV of the fluid between these two operating points is calculated at the point where the thermal damper 70 is situated. In a step 125, a variable volume leak-tight chamber 71 is produced for which the set pressure is equal to Pmax, the maximum variation of volume is greater than or equal to the variation of volume DV and for which the volume stiffness is substantially equal to the ratio between the difference between the saturation pressure and the minimum saturation pressure and the variation of volume (Pmax-Psat)/DV.

It is, furthermore, advantageous for the variation of volume DV and the volume stiffness of the thermal damper 70 to be adjusted in a step 126, such that the obstruction is performed automatically when the temperature of the operating point drops below a given threshold.

1-20. (canceled)

21. A cooling device for regulating a temperature of a heat source comprising:
at least one capillary loop heat pipe formed by:
a capillary evaporator linked to at least one tank of fluid;
at least one condenser;
a heat-transfer fluid circulating in the capillary loop heat pipe;
a first duct in which the heat-transfer fluid circulates in the mostly liquid state;
a second duct in which the heat-transfer fluid circulates in the mostly gaseous state;
the second duct linking the evaporator to the condenser and the first duct linking the condenser to the evaporator to form a closed fluid circulation circuit; and
a thermal damper comprising a variable volume leak-tight chamber comprising a volume stiffness configured for the variable volume leak-tight chamber to be deformed passively within a given operating range of the capillary loop heat pipe as a function of a variation of volume and of distribution of the fluid in the capillary loop heat pipe.

22. The cooling device as claimed in claim 21, wherein the variable volume leak-tight chamber is a bellows.

23. The cooling device as claimed in claim 21, wherein the variable volume leak-tight chamber is sealed and is situated inside the capillary loop heat pipe.

24. The cooling device as claimed in claim 23, wherein the variable volume leak-tight chamber comprises a deformable and hermetically-sealed jacket, and a spring positioned inside the deformable jacket.

25. The cooling device as claimed in claim 23, wherein the variable volume leak-tight chamber comprises a deformable and hermetically-sealed jacket, and a fluid positioned inside the deformable jacket.

26. The cooling device as claimed in claim 23, wherein the variable volume leak-tight chamber comprises a hermetically-sealed deformable jacket, a spring and a fluid positioned inside the deformable jacket.

27. The cooling device as claimed in claim 23, wherein the thermal damper is positioned inside the tank of the capillary evaporator.

28. The cooling device as claimed in claim 23, wherein the thermal damper is positioned in a part of the loop heat pipe situated downstream of the condenser where the liquid phase of the heat-transfer fluid is mainly situated.

29. The cooling device as claimed in claim 21, wherein the variable volume leak-tight chamber is a part of the capillary loop heat pipe containing fluid.

30. The cooling device as claimed in claim 29, wherein the variable volume leak-tight chamber is a part of the tank of the capillary evaporator.

31. The cooling device as claimed in claim 21, wherein the volume stiffness is configured to a saturation pressure of the heat-transfer fluid.

32. The cooling device as claimed in claim 21, wherein a maximum variation of a volume of the chamber of the thermal damper is between 10% and 50% of a total volume of the loop heat pipe.

33. The cooling device as claimed in claim 21, further comprising at least one mechanical abutment to limit a volume variation of the variable volume leak-tight chamber.

34. The cooling device as claimed in claim 21, further comprising a calibration device to modify a set pressure of the thermal damper.

35. The cooling device as claimed in claim 21, wherein an increase in a volume of the variable volume leak-tight chamber passively obstructs arrival of liquid in the tank of the capillary loop heat pipe when the volume reaches a predetermined value.

36. The cooling device as claimed in claim 35, further comprises a reheating system to increase a temperature and a pressure of the fluid in contact with the thermal damper to facilitate a restarting of the loop heat pipe on the basis of a state in which the arrival of liquid in the tank is blocked.

37. A method for producing a cooling device for regulating the temperature of a heat source, wherein the cooling device comprises:
at least one capillary loop heat pipe formed by: a capillary evaporator linked to at least one tank of fluid; at least one condenser; a heat-transfer fluid circulating in the capillary loop heat pipe; a first duct in which the heat-transfer fluid circulates in the mostly liquid state; a second duct in which the heat-transfer fluid circulates in the mostly gaseous state; the second duct linking the evaporator to the condenser and the first duct linking the condenser to the evaporator to form a closed fluid circulation circuit; and
a thermal damper comprising a variable volume leak-tight chamber comprising a volume stiffness configured for the variable volume leak-tight chamber to be deformed passively within a given operating range of the capillary loop heat pipe as a function of a variation of volume and of distribution of the fluid in the capillary loop heat pipe;
the method comprising the steps of:
selecting a set pressure corresponding to an operating point defining a saturation temperature (Tmax) and a saturation pressure (Pmax);
selecting a minimum saturation temperature (Tsat) less than the saturation temperature (Tmax) of the operating point, the minimum saturation temperature (Tsat) corresponding to a minimum saturation pressure (Psat);
selecting a minimum temperature (Tmin) that is less than the minimum saturation temperature (Tsat);
calculating a variation of volume and of distribution of the fluid in the capillary loop heat pipe between the operating point at which fluid is at the saturation temperature (Tmax) and at the saturation pressure (Pmax), and another operating point at which the liquid is at the minimum temperature (Tmin) and a vapor is at the minimum saturation temperature (Tsat);
calculating a volume variation (DV) of the fluid between the two operating points at a position where the thermal damper is situated;
producing a variable volume leak-tight chamber whose set pressure is equal to the minimum saturation pressure (Psat), a maximum volume variation is greater than or equal to the volume variation (DV) and for which the volume stiffness is substantially equal to a ratio between a difference between the saturation pressure (Pmax) and the minimum saturation pressure (Psat) and the volume variation ((Pmax−Psat)/DV), the volume stiffness being configured for the variable volume leak-tight chamber to be deformed passively within the given operating range of the capillary loop heat pipe as a function of the variation of volume and of distribution of the fluid in the capillary loop heat pipe.

38. The method for producing the cooling device as claimed in claim 37, further comprising the step of adjusting the volume variation (DV) and of the volume stiffness of the thermal damper such that an increase of the volume of the variable volume leak-tight chamber passively obstructs arrival of liquid in the tank of the capillary loop heat pipe when the volume reaches a predetermined value.

39. The method for producing the cooling device as claimed in claim 38, further comprising the step of performing obstruction automatically when a temperature of the operating point falls below a given threshold.

40. A satellite comprising at least one radiative surface equipped with a cooling device as claimed in claim 21, comprising a condenser in thermal contact with the radiative surface subject to temperature variations of the environment.
